(19) United States
(12) Patent Application Publication
(10) Pub. No.: US 2026/0333070 A1
(43) Pub. Date: Oct. 22, 2026

(54) APPARATUS AND METHOD FOR PERFORMING ONLINE LEARNING IN WIRELESS COMMUNICATION SYSTEM

(71) Applicant: LG Electronics Inc., Seoul (KR)

(72) Inventors: Sangrim LEE, Seoul (KR); Kyungho LEE, Seoul (KR)

(21) Appl. No.: 19/109,904

(22) PCT Filed: Sep. 20, 2023
(86) PCT No.: PCT/KR2023/014229

§ 371 Date: Mar. 7, 2025

(30) Foreign Application Priority Data
Sep. 21, 2022 (KR) 10-2022-0119469

(51) Int. Cl. H04W 24/02

(52) U.S. Cl. CPC H04W 24/02

(57) ABSTRACT

The present disclosure relates to performing online learning in a wireless communication system. A method for operation a first device in a wireless communication system may include receiving control information from a second device, receiving a data signal based on the control information, restoring data included in the data signal, and performing learning for an artificial intelligence (AI) model used for communication by using the restored data. The learning may be performed by using a label that is determined based on information related to a resource delivering the control information or the data signal.

### TECHNICAL FIELD

The present disclosure relates to a wireless communication system, and more particularly, to an apparatus and method for performing online learning in a wireless communication system.

### BACKGROUND ART

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (mMTC) for providing various services anytime anywhere by connecting a plurality of apparatuses and things but also communication systems considering services/user equipments (UEs) sensitive to reliability and latency have been proposed. To this end, various technical configurations have been proposed.

### DISCLOSURE

### Technical Problem

The present disclosure may provide an apparatus and method for effectively performing online learning of a transmitter and/or receiver model in a wireless communication system.

The present disclosure may provide an apparatus and method for enabling online learning using a signal passing through a real channel in a wireless communication system.

The present disclosure may provide an apparatus and method for determining a label for online learning in a wireless communication system.

The present disclosure may provide an apparatus and method for determining a label for online learning based on a common rule in a wireless communication system.

The present disclosure may provide an apparatus and method for determining a label for online learning based on shared information among devices in a wireless communication system.

The present disclosure may provide an apparatus and method for transmitting a signal including a label among devices in a wireless communication system.

The present disclosure may provide an apparatus and method for determining a label based on a resource delivering a signal including the label in a wireless communication system.

The present disclosure may provide an apparatus and method for determining a label based on information independent of a scheduling result in a wireless communication system.

The present disclosure may provide an apparatus and method for determining a modulation method for a signal including a label in a wireless communication system.

The present disclosure may provide an apparatus and method for signaling a modulation method for a signal including a label in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

### Technical Solution

As an example of the present disclosure, a method for operating a first device in a wireless communication may include receiving control information from a second device, receiving a data signal based on the control information, restoring data included in the data signal, and performing learning for an artificial intelligence (AI) model used for communication by using the restored data. The learning may be performed by using a label that is determined based on information related to a resource delivering the control information or the data signal.

As an example of the present disclosure, a method for operating a second device in a wireless communication may include transmitting control information to a first device, generating a data signal, and transmitting the data signal based on the control information. The data signal may be generated based on a label used to perform learning for an artificial intelligence (AI) model that is used by the first device to process the data signal, and the label may be determined based on information related to a resource delivering the control information or the data signal.

As an example of the present disclosure, a first device in a wireless communication may include a transceiver and a processor coupled with the transceiver. The processor may be configured to receive control information from a second device, to receive a data signal based on the control information, to restore data included in the data signal, and to perform learning for an artificial intelligence (AI) model used for communication by using the restored data. The learning may be performed by using a label that is determined based on information related to a resource delivering the control information or the data signal.

As an example of the present disclosure, a second device in a wireless communication may include a transceiver and a processor coupled with the transceiver. The processor may be configured to transmit control information to a first device, to generate a data signal, and to transmit the data signal based on the control information. The data signal may be generated based on a label used to perform learning for an artificial intelligence (AI) model that is used by the first device to process the data signal, and the label may be determined based on information related to a resource delivering the control information or the data signal.

As an example of the present disclosure, a communication device may include at least one processor and at least one computer memory coupled with the at least one processor and storing an instruction that instructs operations when executed by the at least one processor. The operations may include receiving control information, receiving a data signal based on the control information, restoring data included in the data signal, and performing learning for an artificial intelligence (AI) model used for communication by using the restored data. The learning may be performed by using a label that is determined based on information related to a resource delivering the control information or the data signal.

As an example of the present disclosure, a non-transitory computer-readable medium storing at least one instruction may include the at least one instruction that is executable by a processor. The at least one instruction ray control a device to receive control information from another device, to receive a data signal based on the control information, to restore data included in the data signal, and to perform learning for an artificial intelligence (AI) model used for communication by using the restored data. The learning may be performed by using a label that is determined based on information related to a resource delivering the control information or the data signal.

The above-described aspects of the present disclosure are merely a part of exemplary embodiments of the present disclosure, and various embodiments reflecting technical features of the present disclosure may be derived and understood by those skilled in the art based on the detailed description of the present disclosure below.

### Advantageous Effects

As is apparent from the above description, the embodiments of the present disclosure have the following effects.

According to the present disclosure, online learning using a real channel may be effectively performed.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure.

### DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates a method of processing a transmitted signal applicable to the present disclosure.

FIG. 4 illustrates a communication procedure between a terminal and a base station that are applicable to the present disclosure.

FIG. 5 illustrates an example of a communication structure providable in a 6th generation (6G) system applicable to the present disclosure.

FIG. 6 illustrates an electromagnetic spectrum applicable to the present disclosure.

FIG. 7 illustrates a THz communication method applicable to the present disclosure.

FIG. 8 illustrates a THz signal generation method applicable to the present disclosure.

FIG. 9 illustrates a wireless communication transceiver applicable to the present disclosure.

FIG. 10 illustrates a transmitter structure applicable to the present disclosure.

FIG. 11 illustrates a modulator structure applicable to the present disclosure.

FIG. 12 illustrates a perceptron architecture in an artificial neural network applicable to the present disclosure.

FIG. 13 illustrates an artificial neural network architecture applicable to the present disclosure.

FIG. 14 illustrates an example of a functional framework for applying artificial intelligence (AI) technology applicable to the present disclosure.

FIG. 15 illustrates an example of a procedure for utilizing an artificial intelligence (AI) model applicable to the present disclosure.

FIG. 16 illustrates another example of a procedure for utilizing an artificial intelligence (AI) model applicable to the present disclosure.

FIG. 17 illustrates still another example of a procedure for utilizing an artificial intelligence (AI) model applicable to the present disclosure.

FIG. 18 illustrates a communication procedure based on AI technology applicable to the present disclosure.

FIG. 19 illustrates an example of a procedure of performing online learning for an artificial intelligence (AI) model according to an embodiment of the present disclosure.

FIG. 20 illustrates an example of a procedure of supporting online learning for an artificial intelligence (AI) model according to an embodiment of the present disclosure.

FIG. 21 illustrates an example of a procedure of determining a label for online learning according to an embodiment of the present disclosure.

FIG. 22 illustrates an example of a procedure for performing learning for an artificial intelligence (AI) model according to an embodiment of the present disclosure.

FIG. 23 illustrates examples of a transmitting device and a receiving device that perform channel encoding/decoding by using an artificial intelligence (AI) model according to an embodiment of the present disclosure.

FIG. 24 illustrates examples of a transmitting device and a receiving device that perform offset estimation and compensation by using an artificial intelligence (AI) model according to in embodiment of the present disclosure.

FIG. 25 illustrates an example of a procedure for signaling learning-related capability information according to an embodiment of the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one” “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access system including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

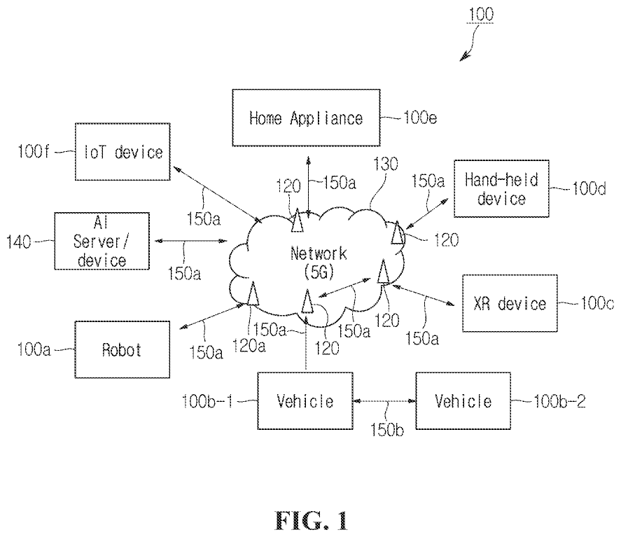

FIG. 1 illustrates an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NP or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication), In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

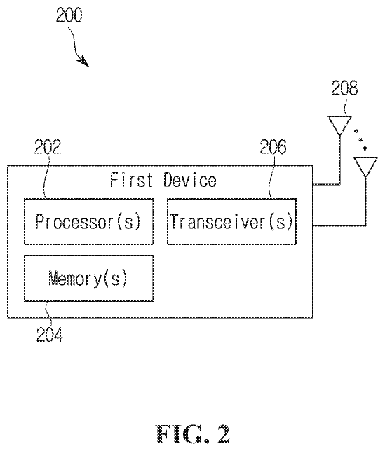

FIG. 2 illustrates an example of a wireless device applicable to the present disclosure.

Referring to FIG. 2, a wireless device 200 may transmit and receive radio signals through various radio access technologies (e.g., LEE, LTE-A, LTE-A pro, NR, 5G, 5G-A, 6G). The wireless device 200 may include at least one processor 202 and at least one memory 204 and may further include at least one transceiver 206 and/or at least one antenna 208.

The processor 202 may be configured to control the memory 204 and/or the transceiver 206 and to implement descriptions, functions, procedures, proposals, methods and/or operational flowcharts disclosed herein. For example, the processor 202 may process information in the memory 204 to generate first information/signal and then transmit a radio signal including the first information/signal through the transceiver 206. In addition, the processor 202 may receive a radio signal including second information/signal through the transceiver 206 and then store information obtained from signal processing of the second information/signal in the memory 204. The memory 204 may be coupled with the processor 202, and store a variety of information related to operation of the processor 202. For example, the memory 204 may store software code including instructions for performing all or some of the processes controlled by the processor 202 or performing the descriptions, functions, procedures, proposals, methods and/or operational flowcharts disclosed herein. Here, the processor 202 and the memory 204 may be part of a communication modem/circuit/chip designed to implement wireless communication technology. The transceiver 206 may be coupled with the processor 202 to transmit and/or receive radio signals through at least one antenna 208. The transceiver 206 may include a transmitter and/or a receiver. The transceiver 206 may be used interchangeably with a radio frequency (RF) unit. In the present disclosure, the wireless device may refer to a communication modem/circuit/chip.

Hereinafter, hardware elements of the wireless device 200 will be described in greater detail. Without being limited thereto, at least one protocol layer may be implemented by at least one processor 202. For example, at least one processor 202 may implement at least one layer (e.g., functional layers such as PHY (physical), MAC (media access control), RLC (radio link control), PDCP (packet data convergence protocol), RRC (radio resource control), SDAP (service data adaptation protocol)). At least one processor 202 may generate at least one protocol data units (PDUs) and/or at least one service data unit (SDU) according to the descriptions, functions, procedures, proposals, methods ad/or operational flowcharts disclosed herein. At least one processor 202 may generate messages, control information, data or information according to the descriptions, functions, procedures, proposals, methods and/or operational flowcharts disclosed herein. At least one processor 202 may generate PDUs, SDLs, messages, control information, data or information according to the functions, procedures, proposals and/or methods disclosed herein and provide the PDUs, SDUs, messages, control information, data or information to at least one transceiver 206. At least one processor 202 may receive signals (e.g., baseband signals) from at least one transceiver 206 and acquire PDUs, SDUs, messages, control information, data or information according to the descriptions, functions, procedures, proposals, methods and/or operational flowcharts disclosed herein.

At least one processor 202 may be referred to as controller, microcontroller, microprocessor or microcomputer. At least one processor 202 may be implemented by hardware, firmware, software or a combination thereof. For example, at least one application specific integrated circuit (ASIC), at least one digital signal processor (DSP), at least one digital signal processing device (DSPD), at least one programmable logic device (PLD) or at least one field programmable gate array (FPGA) may be included in at least one processor 202. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in at least one processor 202 or stored in at least one memory 204 to be driven by at least one processor 202. The descriptions, functions, procedures, proposals, methods and/or operational flowcharts disclosed herein implemented using firmware or software in the form of code, a command and/or a set of commands.

At least one memory 204 may be coupled with at least one processor 202 to store various types of data, signals, messages, information, programs, code, instructions and/or commands. At least one memory 204 may be composed of a read only memory (ROM), a random access memory (RAM), an erasable programmable read only memory (EPROM), a flash memory, a hard drive, a register, a cache memory, a computer-readable storage medium and/or combinations thereof. At least one memory 204 may be located inside and/or outside at least one processor 202. In addition, at least one memory 204 may be coupled with at least one processor 202 through various technologies such as wired or wireless connection.

At least one transceiver 206 may transmit user data, control information, radio signals/channels, etc. described in the methods and/or operational flowcharts of the present disclosure to at least one other apparatuses. At least one transceiver 206 may receive user data, control information, radio signals/channels, etc. described in the methods and/or operational flowcharts of the present disclosure from at least one other apparatuses. For example, at least one transceiver 206 may be coupled with at least one processor 202 to transmit/receive radio signals. For example, at least one processor 202 may perform control such that at least one transceiver 206 transmits user data, control information or radio signals to at least one other apparatuses. In addition, at least one processor 202 may perform control such that at least one transceiver 206 receives user data, control information or radio signals from at least one other apparatus. In addition, at least one transceiver 206 may be coupled with at least one antenna 208, and at least one transceiver 206 may be configured to transmit/receive user data, control information, radio signals/channels, etc. described in the descriptions, functions, procedures, proposals, methods and/or operational flowcharts disclosed herein through at least one antenna 208. In the present disclosure, at least one antenna may be a plurality of physical antennas or a plurality of logical antennas (e.g., antenna ports). At least one transceiver 206 may convert the received radio signals/channels, etc. from RF band signals to baseband signals, in order to process the received user data, control information, radio signals/channels, etc. using at least one processor 202. At least one transceiver 206 may convert the user data, control information, radio signals/channels processed using at least one processor 202 from baseband signals into RF band signals. To this end, at least one transceiver 206 may include (analog) oscillator and/or filters.

The constituent elements described with reference to FIG. 2 may be referred to by different terms from a functional perspective. For example, the processor 202 may be referred to as a controller, the transceiver 206 may be referred to as a communication unit, and the memory 204 may be referred to as a storage unit. In some cases, the communication unit may be used to mean at least a part of the processor 202 and the transceiver 206.

The structure of the wireless device described with reference to FIG. 2 may be understood as a structure of at least some of various devices. For example, the structure of the wireless device exemplified in FIG. 2 may be at least some of the various devices described with reference to FIG. 1 (e.g., the robot 100a, the vehicles 100b-1 and 100b-2, the XR device 100c, the hand-held device 100d, the home appliance 100e, the IoT device 100f, and the AI device/server 100g). Furthermore, according to various embodiments, apart from the constituent elements exemplified in FIG. 2, a device may further include other constituent elements.

For example, a device may be a hand-held device such as a smart phone, a smart pad, a wearable device (e.g., a smart watch, smart glasses) and a portable computer (e.g., a laptop). In this case, the device may further include at least one of a power supply unit for supplying power and including a wired/wireless charging circuit, a battery and the like, an interface unit including at least one port for connecting to another device (e.g., an audio input/output port, a video input/output port), and an input/output unit for inputting and outputting image information/signals, audio information/signals, data and/or information input from a user.

For example, a device may be a moving device such as a mobile robot, a vehicle, a train, a manned/unmanned aerial vehicle (AV) and a ship. In this case, the device may further include at least one of a drive unit including at least one of the engine, motor, powertrain, wheels, brake or steering device of the device, a power supply unit for supplying power and including a wired/Wireless charging circuit, a battery and the like, a sensor unit for sensing state information of the device or surrounding thereof, environment information and user information, an autonomous driving unit for performing functions of lane keeping, speed control, destination setting and the like, or a position measurement unit for obtaining location information of a moving object through a global positioning system (GPS) and various sensors.

For example, a device may be an XR device such as an HMD, a head-up display (HUD) provided in a vehicle, a television set, a smart phone, a computer, a wearable device, a home appliance, digital signage, a vehicle and a robot. In this case, the device may further include at least one of a power supply unit for supplying power and including a wired/wireless charging circuit, a battery and the like, an input/output unit for obtaining control information and data from the outside and outputting a generated XR object, or a sensor unit for sensing state information of the device or surrounding thereof, environment information and user information.

For example, a device may be a robot classifiable for industry, medical, domestic or military purposes depending on intended use or field. In this case, the device may further include at least one of a sensor unit for sensing state information of the device or surrounding thereof, environment information and user information and a drive unit for performing various physical operations like moving robot joints.

For example, a device may be an AI device such as TV, a projector, a smart phone, a PC, a laptop, a terminal for digital broadcasting, a tablet PC, a wearable device, a set top box (STB), a radio, a washing machine, a refrigerator, digital signage, a robot and a vehicle. In this case, the device may further include at least one of an input unit for obtaining various types of data from the outside, an output unit for generating outputs related to sight, hearing and touch, a sensor unit for sensing state information of the device or surrounding thereof, environment information and user information or a training unit for learning of a model composed of artificial neural networks by using learning data.

The structure of the wireless device exemplified in FIG. 2 may be understood as a part of a RAN node (e.g., a base station, a DU, a RU, a RRH). That is, the device exemplified in FIG. 2 may be a RAN node. In this case, the device may further include a wired transceiver for front haul and/or back haul communication. However, if front haul and/or back haul communication is based on wireless communication, the at least one transceiver 206 exemplified in FIG. 2 may be used for front haul and/or back haul communication, and no wired transceiver may be included.

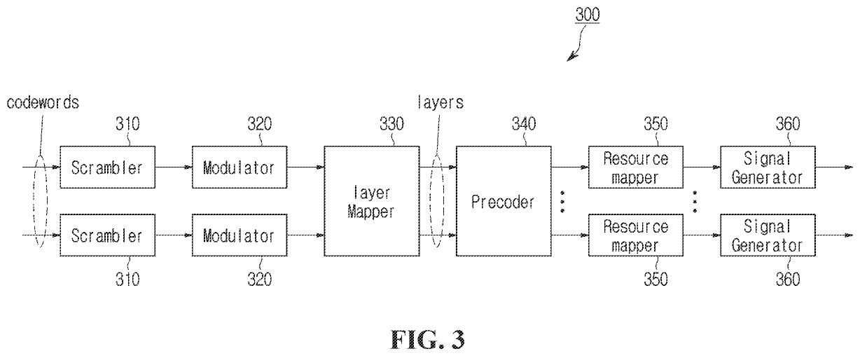

FIG. 3 illustrates a method of processing a transmitted signal applicable to the present disclosure. For example, the transmitted signal may be processed by a signal processing circuit. At this time, a signal processing circuit 300 may include a scrambler 310, a modulator 320, a layer mapper 330, a precoder 340, a resource mapper 350, and a signal generator 360. At this time, for example, the operation/function of FIG. 3 may be performed by the processors 202 and/or the transceiver 206 of FIG. 2. In addition, for example, the hardware element of FIG. 3 may be implemented in the processor 202 of FIG. 2 and/or the transceiver 206 of FIG. 2. For example, blocks 310 to 360 may be implemented in the processor 202 of FIG. 2. In addition, blocks 310 to 350 may be implemented in the processor 202 of FIG. 2 and a block 360 may be implemented in the transceivers 206 of FIG. 2, without being limited to the above-described embodiments.

A codeword may be converted into a radio signal through the signal processing circuit 300 of FIG. 3. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 310. The scramble sequence used for scramble is generated based in an initial value and the initial value may include ID information of a wireless device, etc. The scrambled bit sequence may be modulated into a modulated symbol sequence by the modulator 320. The modulation method may include pi/2-binary phase shift keying (pi/2-BPSK), m-phase shift keying (m-PSK), m-quadrature amplitude modulation (m-QAM), etc.

A complex modulation symbol sequence may be mapped to at least one transport layer by the layer mapper 330. Modulation symbols of each transport layer may be mapped to corresponding antenna port(s) by the precoder 340 (precoding). The output z of the precoder 340 may be obtained by multiplying the output y of the layer mapper 330 by an N*M precoding matrix W. Here, N may be the number of antenna ports and M may be the number of transport layers. Here, the precoder 340 may perform precoding after transform precoding (e.g., discrete Fourier transform (DFT)) for complex modulation symbols. In addition, the precoder 340 may perform precoding without performing transform precoding.

The resource mapper 350 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 360 may generate a radio signal from the mapped modulation symbols, and the generated radio signal may be transmitted to another device through each antenna. To this end, the signal generator 360 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 310 to 360 of FIG. 3. For example, the wireless device (e.g., 200 of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

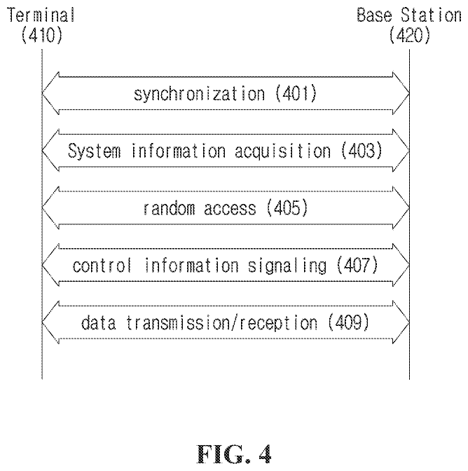

FIG. 4 illustrates a communication procedure between a terminal and a base station that are applicable to the present disclosure. FIG. 4 exemplifies an operation of transmitting and/or receiving data by a terminal 410 and a base station 420 and operations performed prior to the operation.

Referring to FIG. 4, at step S401, the terminal 410 and the base station 420 perform synchronization. For example, the terminal 410 performs an initial cell search operation. Specifically, the terminal 410 may detect at least one synchronization signal that is transmitted from the base station 420 according to a predefined rule. Herein, the synchronization signal may include a plurality of synchronization signals that are classified according to structure or purpose (e.g., a primary synchronization signal, a secondary synchronization signal). Thus, the terminal 410 may identify the boundary of a frame, a subframe, a slot and/or a symbol of the base station 420 and obtain information on the base station 420 (e.g., a cell identifier).

At step S403, the terminal 410 obtains system information transmitted from the base station 420. The system information is information related to the attribute, feature and/or capability of the base station 420, which is necessary to access the base station 420 and to use a service, and may be classified according to a content (e.g., whether or not it is absolutely necessary for access) and a transmission structure (e.g., a channel used therein whether or not on-demand provision is performed) and be classified, for example, into a master information block (MIB) and a system information block (SIB). If necessary, the terminal 410 may transmit a signal for requesting system information before receiving system information. However, the request and provision of the system information may be performed after a random access procedure described below.

At step S405, the terminal 410 and the base station 420 perform the random access procedure. The terminal 410 may transmit and/or receive at least one message (e.g., a random access preamble, a random access response (RAR) message) for the random access procedure based on information related to a random access channel of the base station 420 (e.g., a channel position, a channel structure, a structure of a supported preamble), which is obtained through the system information. For example, the terminal 410 may transmit a preamble (e.g., MSG1) through a random access channel, receive a RAR message (e.g., MSG2), transmit a message (e.g., MSG3) including information related to the terminal 410 (e.g., identification information) by using scheduling information included in the RAR message to the base station 420, and receive a message (e.g., MSG4) for contention resolution and/or connection configuration. As another example, MSG1 and MSG3 as a single message or MSG2 and MSG4 as a single may be transmitted and received.

At step S407, the terminal 410 and the base station 420 perform signaling of control information. Herein, control information may be defined in various layers such as a layer for controlling connection (e.g., a radio resource control (RRC) layer), a layer for processing mapping between a logical channel and a transmission channel (e.g., a media access control (MAC) layer), and a layer for processing a physical channel (e.g., a physical (PHY) channel). For example, the terminal 410 and the base station 420 may perform at least one of signaling for establishing connection, signaling for determining a communication-related configuration, or signaling for indicating an allocated resource.

At step S409, the terminal 410 and the base station 420 transmit and/or receive data. In other words, the terminal 410 and the base station 420 may process data based on the signaling of the control information and transmit and/or receive the data. For example, when transmitting the data, the terminal 410 or the base station 420 may perform, for information bits, at least one of channel encoding, rate matching, scrambling, constellation mapping, layer mapping, waveform modulation, antenna mapping or resource mapping. On the other hand, when receiving the data, the terminal 410 or the base station 420 may perform at least one of signal extraction from a resource, waveform demodulation for each antenna, signal arrangement considering layer mapping, constellation demapping, descrambling, or channel decoding.

### 6G Communication System and Core Implementation Technology of 6G System

A 5G system defines various operation bands within a frequency range 1 (FR1) from 410 MHz to 7,125 MHz and a frequency range 2 (FR2) from 24,250 MHz to 71,000 MHz. Various frequencies are being discussed as operation bands of the subsequent 6G system, and the use of higher frequencies than the 5G system is under consideration for a broader bandwidth and a higher transmission speed. Among the frequencies, the use of a THz (Terahertz) frequency band is under discussion including a range from about 100 GHz to 10 THz. The THz frequency band is a band with both the penetrability of radio waves and the straightness of light waves, and communication using the THz frequency band is expected to serve as a transitional role from the existing radio wave-centered communication to light wave-based communication.

Thus, a 6G (wireless communication) system using a THz frequency band has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below.

TABLE 1

| | |
|---|---|
| Per device peak data rate | 1 Tbps |
| E2E latency | 1 ms |
| Maximum spectral efficiency | 100 bps/Hz |
| Mobility support | Up to 1000 km/hr |
| Satellite integration | Fully |
| AI | Fully |
| Autonomous vehicle | Fully |
| XR | Fully |
| Haptic Communication | Fully |

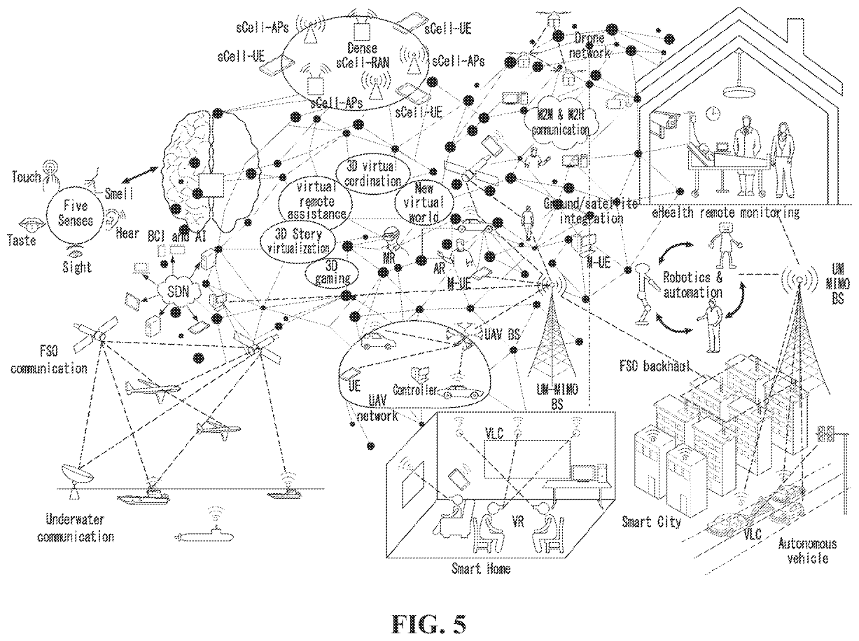

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security. FIG. 5 illustrates an example of a communication structure providable in a 6G system applicable to the present disclosure. Referring to FIG. 5, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

For core implementation technologies of 6G system, artificial intelligence (AI), Terahertz (THz) communication, optical wireless technology, FS0 backhaul network, massive MIMO technology, blockchain, 3D networking, quantum communication, unmanned aerial vehicles, cell-free communication, wireless information and energy transfer (WIET), integration of sensing and communication, integration of access and backhaul networks, hologram beamforming, big data analysis, large intelligence surface (LIS) and other technologies may be adopted.

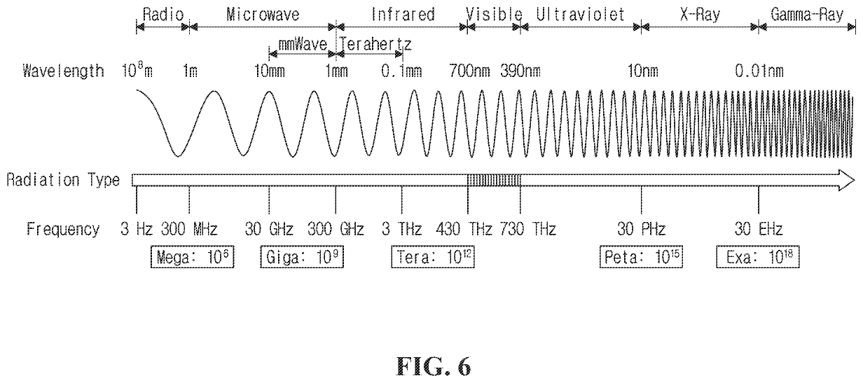

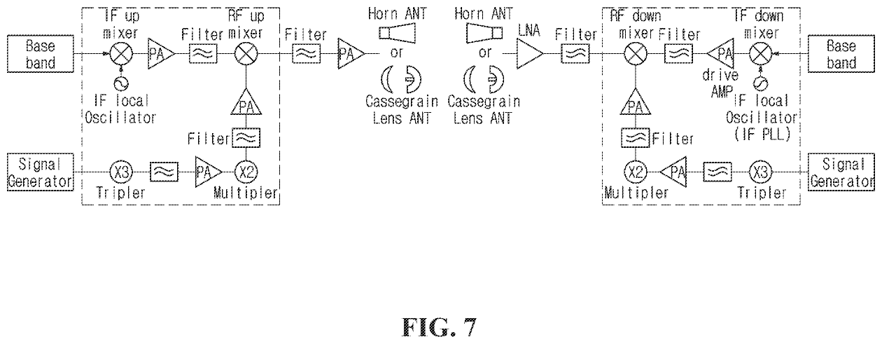

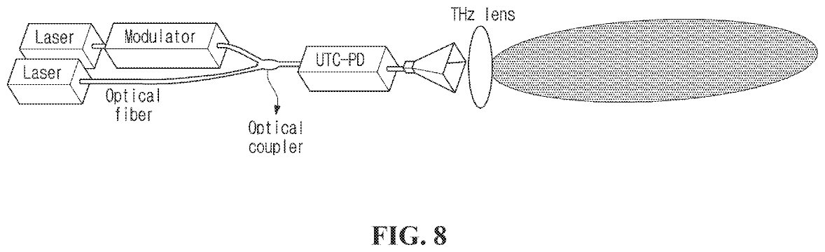

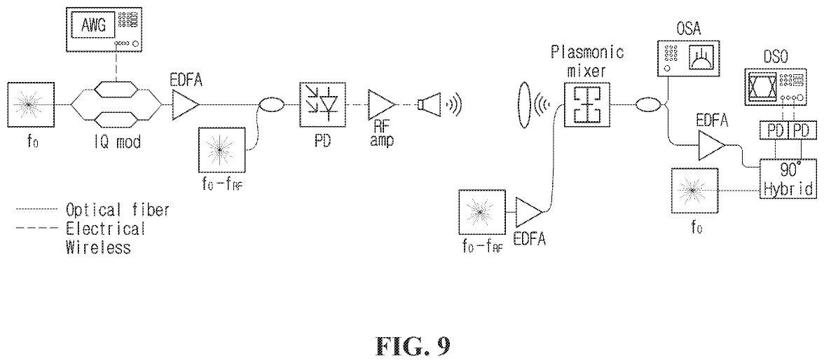

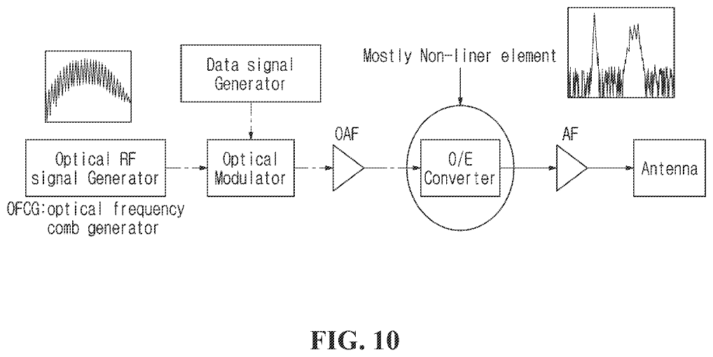

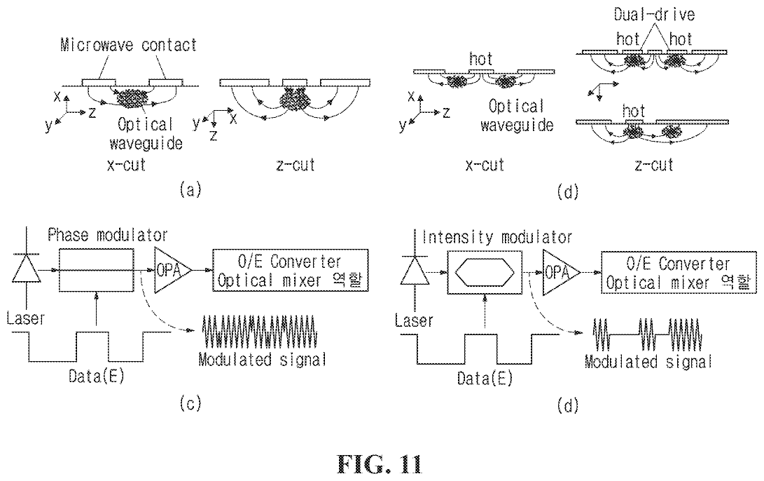

For example, THz communication is communication using a spectrum in a frequency band ranging from 0.1 THz to 10 THz with a corresponding wavelength in a range from 0.03 mm to 3 mm as shown in FIG. 6 and may be implemented using circuit elements in a structure as shown in FIG. 7. In addition, the optical wireless technology is a technology of generating and modulating a THz signal by using an optical element and may be implemented based on devices with structures as shown in FIG. 8, FIG. 9, FIG. 10 and FIG. 11.

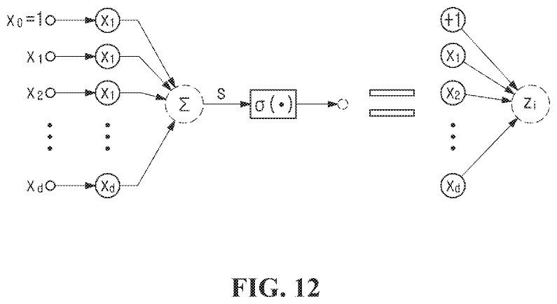

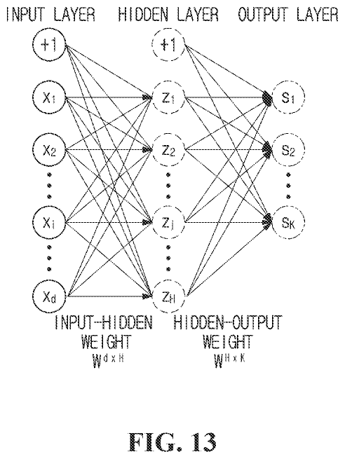

In addition, AI may be implemented based on various models such as neural networks and machine models. For example, an AI model with a neural network architecture may be based on the structure of perceptrons as shown in FIG. 12. Referring to FIG. 12, an artificial neural network may consist of a plurality of perceptrons. According to a structure of perceptrons, an input vector x={x1, x2, . . . , xd} is input, each component is multiplied by a weight {W1, W2, . . . , Wd}, results are all added up, and then an activation function σ( ) is applied. For a large artificial neural network architecture, when expanding the simplified perceptron structure illustrated in FIG. 12, an input may be applied to different multidimensional perceptrons. As perceptrons are stacked, a neural network with an input layer, a hidden layer and an output layer may be constructed as shown in FIG. 13.

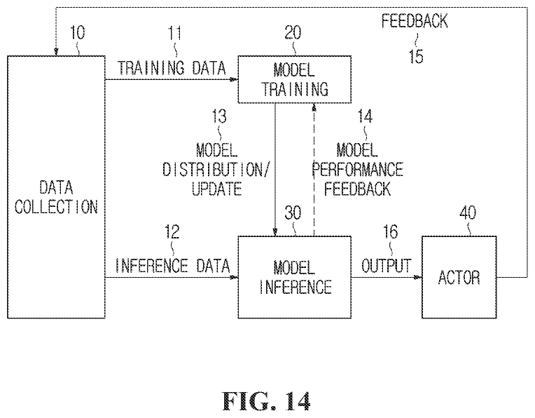

AI technology using such a neural network architecture as described above may be operated based on such a functional framework as shown in FIG. 14 below. FIG. 14 illustrates an example of a functional framework for applying AI technology applicable to the present disclosure. First, a data collection block 1410 generates training data 1411 and/or inference data 1411 including processed input data by performing data preparation for input data collected from objects (e.g., a UE, a RAN node, a network node). A model training block 1420 performs training on an AI model by using the training data 1411 and provides information on the trained model to a model inference block 1430. The model inference block 1430 generates an output 1416 by performing inference and/or prediction with the inference data 1411. In addition, the model inference block 1430 may provide model performance feedback 1414 to the model training block 1420. Herein, the output 1416 means an inference output of the AI model, which is generated by the model inference block 1430, and detailed information of the inference output may be different according to use cases. An actor block 1440 triggers or performs a designated task/operation based on the output 1416. The actor block 1440 may trigger a task/operation for another object (e.g., at least one UE, at least one RAN node, at least one network node) and itself. Among the above-described functions exemplified in FIG. 14, any one function may be performed in collaboration of two or more entities of a RAN, a network node, an OAM of a network provider, or a UE. This may be called a split AI operation.

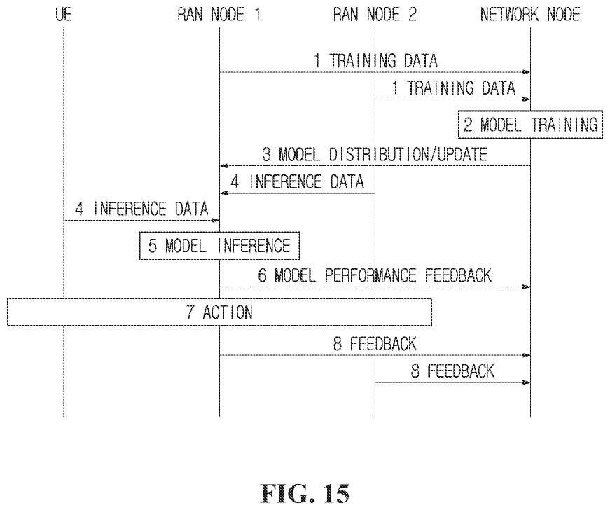

FIG. 15 illustrates an example of a procedure for utilizing an AI model applicable to the present disclosure. FIG. 15 exemplifies a case in which a model training function (e.g., the function of the model training block 1420) is included in a network node and a model inference function (e.g., the function of the model inference block 1430) is included in a RAN node. Referring to FIG. 15, at step S1, a RAN node 1 and a RAN node 2 transmit input data (e.g., training data) for training of an AI model to a network node. Herein, the RAN node 1 and the RAN node 2 may transmit data collected from a UE (e.g., measurements of the UE related to RSRP, RSRQ and SINR of a serving cell and a neighbor cell, the position and speed of the UE) to the network node together. At step S2, the network node trains the AI mode by using the received training data. At step S3, the network node distributes/updates the AI model to the RAN node 1 and/or the RAN node 2. The RAN node 1 and/or the RAN node 2 may keep model training based on the received AI model. In this procedure, it is assumed that the AI model is distributed/updated only to the RAN node 1. At step S4, the RAN node 1 received input data (e.g., inference data) for AI model inference from the UE and the RAN node 2. At step S5, the RAN node 1 generates output data (e.g., a prediction or determination) by performing AI model-based inference using the received inference data. At step S6, if applicable, the RAN node 1 may transmit model performance feedback to the network node. At step S7, the RAN node 1, the RAN node 2 and the UE (or the RAN node 1 and the UE, or the RAN node 1 and the RAN node 2) perform an action based on the output data. For example, in the case of a load balancing action, the UE may moves from the RAN node 1 to the RAN node 2. At step S8, the RAN node 1 and the RAN node 2 transmit feedback information to the network node.

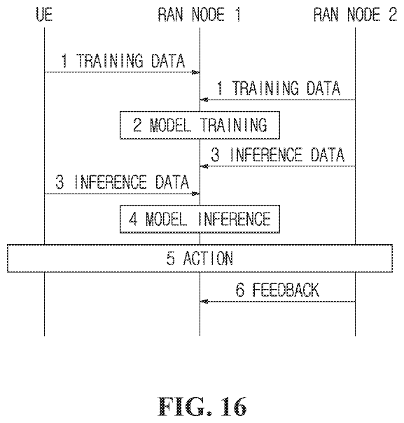

FIG. 16 illustrates another example of a procedure for utilizing an AI model applicable to the present disclosure. FIG. 16 exemplifies a case in which a model training function (e.g., the function of the model training block 1420) and a model inference function (e.g., the function of the model inference block 1430) are included in a RAN node. Referring to FIG. 16, at step S1, a UE and a RAN node 2 transmit input data (e.g., training data) for training of an AI model to a RAN node 1. At step S2, the RAN node 1 trains the AI mode by using the received training data. At step S3, the RAN node 1 receives input data (e.g., inference data) for AI model-based inference from the UE and the RAN node 2. At step S4, the RAN node 1 generates output data (e.g., a prediction or determination) by performing AI model-based inference using the received inference data. At step S5, the RAN node 1, the RAN node 2 and the UE (or the RAN node 1 and the UE, or the RAN node 1 and the RAN node 2) perform an action based on the output data. For example, in the case of a load balancing action, the UE may moves from the RAN node 1 to the RAN node 2. At step S6, the RAN node 2 transmits feedback information to the RAN node 1.

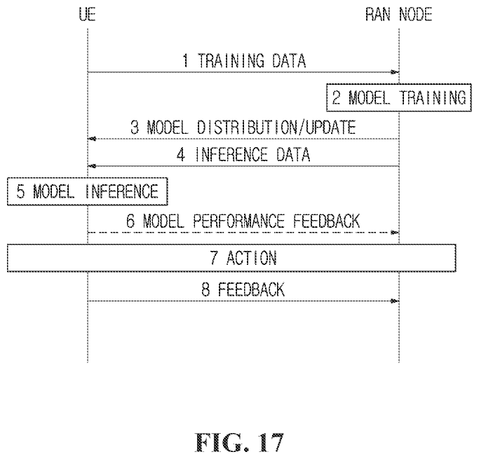

FIG. 17 illustrates still another example of a procedure for utilizing an AI model applicable to the present disclosure. FIG. 17 exemplifies a case in which a model training function (e.g., the function of the model training block 1420) is included in a RAN node and a model inference function (e.g., the function of the model inference block 1430) is included in a UE. Referring to FIG. 17, at step S1, the UE transmits input data (e.g., training data) for training of an AI model to the RAN node. Herein, the RAN node may collect data from various UEs and/or another RAN node. At step S2, the RAN node trains the AI model by using the received training data. At step S3, the RAN node distributes/updates the AI model to the UE. The UE may keep performing model training based on the received AI model. At step S4, the UE receives input data for AI model-based inference (e.g., inference data) from the RAN node and/or another UE. At step S5, the UE generates output data (e.g., a prediction or determination) by performing AI model-based inference using the received inference data. At step S6, if applicable, the UE may transmit model performance feedback to the RAN node. At step S7, the UE and the RAN node perform an action based on the output data. At step S8, the UE transmits feedback information to the RAN node.

According to the above-described framework and procedure, in a wireless communication system, an AI model may be trained and utilized. In the above-described framework and procedure, various types of data such as input data, training data and inference data are introduced, and detailed contents of the above-described data may vary according to a task used in an AI model. For example, information used in various embodiments of the present disclosure to be described below may be included in the above-described data.

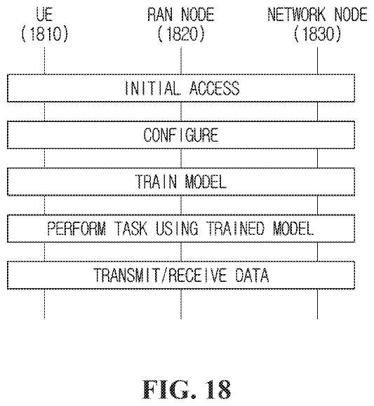

FIG. 18 illustrates a communication procedure based on AI technology applicable to the present disclosure. Detailed procedures exemplifies in FIG. 18 may be combined with various embodiments of the present disclosure to be described below. For example, data generated according to various embodiments of the present disclosure may be used for an action (e.g., configuration, training, inference and/or data transmission/reception) in at least one of the detailed procedures exemplified in FIG. 18. As another example, according to various embodiments of the present disclosure, a result of inference exemplified in FIG. 18 may be used to transmit and/or receive data.

Referring to FIG. 18, at step S1801, at least one of a UE 1810, a RAN node 1820 or a network node 1830 performs an initial access procedure. For example, at this step, at least one of an initial cell search action, a system information acquisition action, a random access action, or a registration action may be performed. At step S1803, at least one of the UE 1810, the RAN node 1820 or the network node 1830 performs a configuration procedure. Through the configuration procedure, a parameter, a resource, a linkage and/or an entity, which are necessary to performing subsequent procedures, may be determined and/or generated in layers between the UE 1810 and the RAN node 1820 and/or in at least one layer between the UE 1810 and the network node 1830. Herein, the configuration procedure may be performed based on the information, state and/or feature of an AI model that is used for subsequent training and inference.

At step S1805, at least one of the UE 1810, the RAN node 1820 or the network node 1830 performs a model training procedure. At least one of the UE 1810, the RAN node 1820 or the network node 1830 may collect training data and perform learning by the training data. For example, the model training procedure may be performed as described with reference to FIG. 15, FIG. 16 or FIG. 17. If an offline-trained model is used, this step may be omitted.

At step S1807, at least one of the UE 1810, the RAN node 1820 or the network node 1830 performs a task by using a trained model. That is, the task may be performed by a result of inference and/or prediction using the trained model. For example, the task may be a procedure belonging to a communication protocol, be a proactive action for subsequent data transmission and/or reception, be related to data transmission and/or reception, or be related to processing of data (e.g., encoding, decoding).

At step S1809, at least one of the UE 1810, the RAN node 1820 or the network node 1830 transmits and/or receives data. Herein, a result of the task performed at step S1807 may be used. In some cases, the task performed at step S1807 may include transmission and/or reception of data, and in this case, this step is a part of step S1807 and thus may be omitted.

### Specific Embodiments of the Present Disclosure

The present disclosure relates to learning of an AI model that is applied to implement at least some functions of a device in a wireless communication system, and the present disclosure is directed to performing online learning by using a signal that has passed through a real channel. Specifically, the present disclosure relates to a technology for determining a label of learning data that is necessary to perform online learning, and various embodiments for sharing label data among a plurality of devices performing communication are proposed. That is, the present disclosure proposes a technology of pre-assigning a label necessary for supervised learning, when performing online learning, and performing the online learning by using the pre-assigned label.

A lot of studies are underway to achieve better performance than traditional techniques by using AI technologies in a wireless communication environment. Herein, forms of learning of AI models may be divided mainly into two types, that is, online learning and offline learning.

First, offline learning is a method of performing learning offline based on a modeled transmission/reception simulation. As offline learning is performed offline, it assumes that there is an absolute being which knows everything in the simulation. That is, either in a channel environment or in data that are really generated, knowledge of everything may be assumed such that a label is secured in advance for supervised learning. However, for an offline learning technique, it is impossible to model everything that may occur in a real environment, and in this regard, there is a limitation that the technique operates well only in a modeled environment.

On the other hand, online learning is a method of performing learning by using a signal passing through a real channel, while being deployed in a wireless communication environment. In the case of online learning, learning may be performed according to environmental changes or by adapting an unmodeled part to a real environment. As compared with offline learning, online learning is performed based on real environmental data, which enables better performance to be secured.

Considering the advantages and disadvantages of offline learning and online learning respectively, it is possible that offline line is performed primarily for a part, which is possible to model, from the perspective of pre-training and additional online learning is performed to keep updating a neural network after actual deployment. However, there is a significant problem in performing online learning. Specifically, when typical supervised learning is applied to online learning, there is a problem regarding how a receiving device will know a label in a real communication situation.

For example, in case a neural network for performing channel estimation is designed, even if a transmitting device transmits a reference signal with a mutually known value and a receiving device receives the reference signal, a channel is estimated while being unknown. There is no method for knowing a real channel while random noise exists, and the receiving device is incapable of knowing the ground truth, that is, a label. If a label is unknown, it means that an error caused by channel estimation is unknown, which makes it impossible to perform learning.

As another example, there is a case of a channel equalizer. For learning of the channel equalizer, a receiver signal and a channel-equalized signal are needed as input and output respectively. That is, there is a limitation that a channel affects data, an estimated channel is treated as ground truth, as mentioned above, and learning is performed. Accordingly, because a real channel is unknown in an online learning environment, subsequent functional blocks do not avoid being affected.

Accordingly, in online learning, a method for sharing a label between a transmitting device and a receiving device is needed. Thus, the present disclosure proposes a method for determining a label by a common rule and various embodiments related thereto.

As described above, for online learning, a method for delivering a label for supervised learning of a transmitting device and a receiving device is needed. As one possible method, end-to-end learning may be performed with a bit sequence transmitted from a transmitting device and a bit sequence restored in a receiving device. Herein, it is possible to consider a method of performing learning at a data level through cyclic redundancy check (CRC). However, if the CRC check is successful, corresponding data is interpreted to be accurate so that the restored data will be used as a label. In this case, because there is no error, the necessity of learning is low. On the other hand, if the CRC check fails, because the actually transmitted bit sequence is unknowable, learning is also impossible. As a result, in a situation where random data is transmitted, learning is impossible. In addition, as described above, in a situation where a channel itself is unknown through a reference signal, online learning is also impossible.

Accordingly, rather than an approach for delivering a label for online learning in real time, an approach for pre-assigning a label is more desirable. Accordingly, a method for determining a label is needed, and it is necessary to pre-assign a rule that a transmitting device and a receiving device can interpret identically according to the new method.

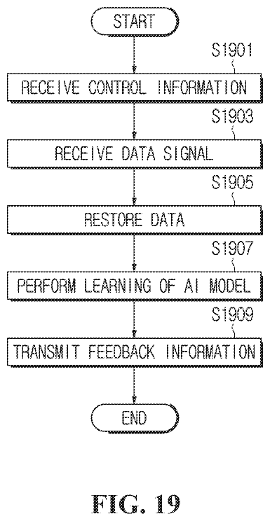

FIG. 19 illustrates an example of a procedure of performing online learning for an AI model according to an embodiment of the present disclosure. FIG. 19 exemplifies a method for operating a terminal, that is, actions performed by a device for learning of an AI model used for a receiving operation.

Referring to FIG. 19, at step S1901, the device receives control information. According to an embodiment, the control information may include scheduling information for a data signal to be received later. For example, the control information may include a DCI or an SCI. According to another embodiment, the control information may include configuration information for online learning. For example, the configuration information for online learning may include at least one of information related to an online learning segment, information related to a trained AI model, or information related to a rule for determining a label. Herein, the control information may be received through a single message or a plurality of messages.

At step S1903, the device receives a data signal. For example, the device may receive the data signal based on the control information received at step S1901. For example, the device may receive the data signal through a resource that is indicated by scheduling information in the control information. Alternatively, the device may receive the data signal during an online learning segment that is indicated by configuration information in the control information.

At step S1905, the device restores data. The data may be restored by a series of processing actions for the received data signal. For example, the series of processing actions include at least one of OFDM demodulation, channel estimation, equalization, constellation demapping or channel decoding. Herein, at least one of the series of processing actions is performed using an AI model. By restoring the data, the device may acquire an estimation of a bit sequence included in the data signal. Herein, the bit sequence may be included in the data signal in a form of a transport block or a form of uncoded data. Herein, the estimation of the bit sequence may have an error relative to a transport block or bit sequence transmitted from a counterpart device.

At step S1907, the device performs learning for the AI model. The device may perform learning by using the restored data. To this end, the device determines a transmission value for the restored data, that is, a value of the bit sequence transmitted from the counterpart device. In other words, the device determined a label. According to an embodiment, the device may determine a label according to a predefined rule based on the control information or information related to the data signal. Accordingly, the device may calculate an error of the estimation for the transport block based on the label, determine a loss value based on the error, and update weights of the AI model. Herein, the AI model may include a neural network that is designed to perform at least one function for communication (e.g., signal processing, data processing, channel estimation, beam management).

At step S1909, the device transmits feedback information. For example, the feedback information is feedback information corresponding to the data signal and may include HARQ-ACK/NACK. As another example, according to an embodiment, the feedback information may include gradient information that the counterpart device uses to update the AI model. That is, in case the neural network of the AI model, which is the target of online learning, exists across the counterpart device and the device, gradient information generated by a backpropagating action of a neural network in the device may be delivered to the counterpart device for learning of a neural network used in the counterpart device.

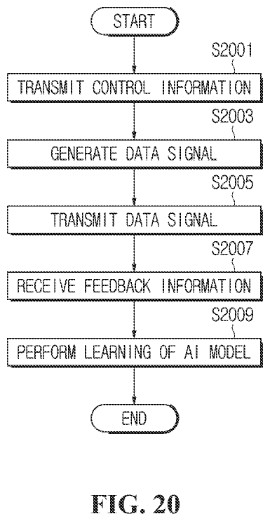

FIG. 20 illustrates an example of a procedure of supporting online learning for an AI model according to an embodiment of the present disclosure. FIG. 20 exemplifies a method for operating a base station or a terminal, that is, actions of a device for supporting learning of an AI model used for a receiving operation in a counterpart device.

Referring to FIG. 20, at step S2001, the device transmits control information. According to an embodiment, the control information may include scheduling information for a data signal to be received later. For example, the control information may include a DCI or an SCI. According to another embodiment, the control information may include configuration information for online learning. For example, the configuration information for online learning may include at least one of information related to an online learning segment, information related to a trained AI model, or information related to a rule for determining a label. Herein, the control information may be received through a single message or a plurality of messages.

At step S2003, the device generates a data signal. The data signal may be generated through a series of actions including at least one of channel encoding, constellation mapping, resource mapping, or OFDM modulation for a transport block. Herein, according to an embodiment, the device may determine a label for online learning and generate a transport block including the label. According to an embodiment, the device may determine a label according to a predefined rule based on the control information or information related to the data signal.

At step S2005, the device transmits the data signal. For example, the device may transmit the data signal generated at step S2003 based on the control information transmitted at step S2001. For example, the device may transmit the data signal through a resource that is indicated by scheduling information in the control information. Alternatively, the device may transmit the data signal during an online learning segment that is indicated by configuration information in the control information.

At step S2007, the device receives feedback information. For example, the feedback information is feedback information corresponding to the data signal and may include HARQ-ACK/NACK. As another example, according to an embodiment, the feedback information may include gradient information for updating the AI model used in the device. That is, in case the neural network of the AI model, which is the target of online learning, exists across the counterpart device and the device, gradient information generated by a backpropagating action of a neural network in the counterpart device may be delivered to the device for learning of a neural network used in the device.

At step S2009, the device performs learning for the AI model. The device may update weights included in the AI model by performing backpropagation using gradient information included in the feedback information received at step S2007. However, if no gradient information is included in the feedback information received at step S2007, this step may be omitted.

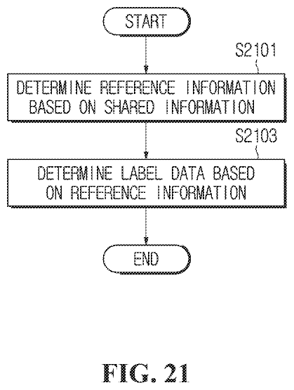

FIG. 21 illustrates an example of a procedure of determining a label for online learning according to an embodiment of the present disclosure. FIG. 21 exemplifies actions for generating label data for online learning, that is, a method for operating a device that performs communication with another device. Herein, the device may be a base station or a terminal.

Referring to FIG. 21, at step S2091, the device determines reference information based on shared information. Herein, the shared information means information that is commonly known by an operation of transmitting and/or receiving label data without a separate additional procedure. For example, according to various embodiments, the shared information may include information related to a resource for delivering at least one signal transmitted in a procedure of transmitting and/or receiving the label data through a channel. In this case, identification information, position information and an index for the resource may be determined as the reference information. As a signal for delivering a signal can be known without an additional procedure, if a same rule is used, a same label may be determined. For example, information related to the resource may include at least one of a frame index, a subframe index, a slot index, a subcarrier index, a frequency index, a number of RBs, a RB index, a start symbol index, an SSB detection time, or a repetition number of data signal.

At step S2093, the device determines label data based on the reference information. Bit sequences, which are available as the label data, and a label index corresponding to the bit sequences are predefined in a table form or a formula. In addition, a rule for deriving the label index from the reference information is also predefined. Accordingly, when the reference information is determined, the device may determine the label index based on the reference information and determine the label data based on the determined label index.

As described with reference to FIG. 21, label data may be determined based on shared information such as information related to a resource for delivering a signal. As a resource for delivering control information or a data signal is information that can be known without an additional procedure in a device and a counterpart device, if a same rule is used, a same label may be determined. For example, information related to the resource may include at least one of a frame index, a subframe index, a slot index, a subcarrier index, a frequency index, a number of RBs, a RB index, a start symbol index, an SSB detection time, or a repetition number of data signal. In addition, a rule for determining a label may be predefined.

As described above, because devices related to online learning determine a label based on a predefined rule, a label with a common value may be shared. To this end, definitions are needed for a label index and a label bit sequence that are predefined, a linkage rule based on the number of labels and shared information (e.g., indexes of frames, subframes or slots), and coding or non-coding with bit sequence. According to various embodiments, a label may be defined according to a predefined rule as shown in Table 2 below.

TABLE 2

| Label index | Bit sequence (label) |
|---|---|
| 1 | 0100100110 . . . 11111010101 |
| 2 | 0011000110 . . . 10010001001 |
| . . . | . . . |
| N | 1110111011 . . . 11101111011 |

As shown in the examples of Table 2, a label index and a bit sequence, which is a corresponding label, may be pre-assigned between a transmitting device and a receiving device. Herein, the number of label indexes and a length of a label (e.g., a bit size) may be pre-assigned. Herein, the bit size of a label may be pre-assigned in various ways. According to various embodiments, apart from a table, other methods may be used to generate pre-assigned bit sequences based on indexes. For example, a label may be determined by using a function with a label index or a value related to the label index as inputs. In addition, a plurality of tables may be defined, and any one table may be selectively used according to a trained AI model, a task and the like.

Based on the pre-assigned label indexes and labels that are described above, a transmitting device and a receiving device may interpret a label during an online learning procedure described below. While online learning is performed, a terminal may be in a connected state. Accordingly, through a synchronization procedure, a base station and the terminal will commonly know an index of a frame or a subframe. As a result, based on the index of a frame or a subframe, the transmitting device and the receiving device may interpret the frame index as, for example, “Label index=function (frame index, N)”. Herein, the function may output a remainder by dividing a frame index by N, that is, the number of labels (# of labels). Alternatively, the function may output a quotient by dividing a frame index by N, that is, the number of labels (# of labels).

For example, systemFrameNumber in an MIB of NR has one value between 0 and 1023. If the number of labels N is 1024 and a frame number of 23, a bit sequence corresponding to the label index 23 is used as a label. Accordingly, according to an embodiment, the transmitting device may generate and transmit a transport block (TB) including a bit sequence with a bit size of 512. The receiving device may receive a signal transmitted from the transmitting device, determine a bit sequence assigned to correspond to the label index 23 as a label, that is, ground truth by decoding the received signal, and compute a bit error, that is, a loss function. Based on the loss function, the receiving device may perform backpropagation and thus update a neural network.

In the above-described embodiment, a frame index is used to derive a label index. According to another embodiment, in a process of interpreting a label index, instead of a frame index, a subframe index may be used as shown in “Label index=function (subframe index, N)”. Herein, subframe index may be defined as “frame index×# of subframes in frame+subframe index”. In addition, instead of a frame index, a slot index may be used as shown in “Label index=function (slot index, N)”. Herein, slot index may be defined as “slot index=subframe index×# of slots in subframe+slotindex”.

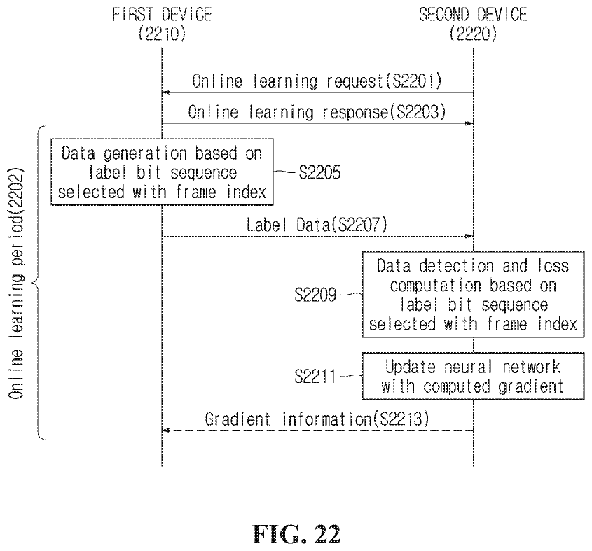

FIG. 22 illustrates an example of a procedure for performing learning for an AI model according to an embodiment of the present disclosure. FIG. 22 exemplifies signal exchange for online learning of an AI model (e.g., a neural network model) used in at least one of a first device 2210 and a second device 2220.

Referring to FIG. 22, at step S2201, the second device 2220 transmits an online learning request message to the first device 2210. In other words, the second device 2220 requests to perform online learning for an AI model used in the second device 2220. According to an embodiment, the online learning request message may include at least one of information related to the AI model to be trained or information related to learning history of the AI model.

At step S2203, the first device 2210 transmits an online learning response message to the second device 2220. In other words, the first device 2210 gives a response regarding whether or not to accept the online learning request message. In this embodiment, the online learning response message instructs online learning to be performed. According to an embodiment, the online learning response message may include, as configuration information for online learning, at least one of, for example, information related to a start point of an online learning segment 2202 (e.g., the number of a frame, a subframe or a slot, a subframe or slot unit offset), information related to a label used for online learning (e.g., a label determination rule or table allocation, available label indexes) or information indicating information related to feedback on gradient information (e.g., whether or not there is feedback, resource allocation for feedback).

At step S2205, the first device 2210 generates data based on a label bit sequence that is selected by using a frame index. That is, the first device 2210 may identify a frame index, determine a label index based on the identified frame index, and identify a bit sequence corresponding to the determined label index.

At step S2207, the first device 2210 transmits label data to the second device 2220. That is, the first device 2210 may transmit a signal including the identified bit sequence of step S2205 as payload. To this end, although not illustrated in FIG. 22, before the label data is transmitted, the first device 2210 or the second device 2220 may transmit control information. For example, the control information may include scheduling information for the label data.

At step S2209, the second device 2220 detects data and calculates loss based on a label bit sequence selected by the frame index. That is, the second device 2220 performs demodulation and decoding for a received signal and compares bits obtained through decoding and the label bit sequence. If the bits and the label bit sequence are identical to each other, the loss is zero. However, if the bits and the label bit sequence are different from each other, a loss value may be determined based on a difference between the bits and the label bit sequence.

At step S2211, the second device 2220 updates a neural network by using a calculated gradient. In other words, the second device 2220 may update weights included in the neural network by performing a backpropagating action based on the loss value. That is, the second device 2220 may update a weight value of the neural network by using a gradient such that the loss value decreases.

At step S2213, the second device 2220 transmits gradient information to the first device 2210. This step is performed when at least a part of a trained AI model is also used in the first device 2210. That is, if the trained AI model is used only in the second device 2220, that is, if the trained AI mode is related only to the operation of the second device 2220, this step may be omitted.

In FIG. 22, the first device 2210 and the second device 2220 are two devices performing communication, and the first device 2210 may use an AI model to perform a transmitting operation, while the second device 2220 may use an Ail model to perform a receiving operation. In case downlink communication is performed, the first device 2220 and the second device 2220 may be understood as a base station and a terminal. In case uplink communication is performed, the first device 2220 and the second device 2220 may be understood as a terminal and a base station. In case sidelink communication is performed, the first device 2220 and the second device 2220 may be understood as a terminal and a terminal. That is, the above-described procedure may be performed for a combination of a base station and a terminal, a combination of a terminal and a base station, and a combination of a terminal and a terminal, and the like.

As shown in the embodiment described with reference to FIG. 22, devices may determine a label by using an identical rule based on an index of a subframe or slot. Accordingly, if an index of a frame, a subframe or a slot is common, devices may determine a label with a same bit sequence. As the frame, the subframe or the slot are a unit of a resource for delivering a signal transmitted and received between devices, if a signal is transmitted and received, the devices may know a same index, irrespective of whether or not there is an error in data included in the signal. Herein, the frame, the subframe or the slot related to the used index may be a frame, a subframe or a slot for delivering a data signal including a label as a transport block, a frame, a subframe or a slot for delivering allocation information for the data signal, a frame, a subframe or a slot for delivering configuration information related to online learning, or a frame, a subframe or a slot for delivering an SSB from which one of the devices detects a synchronization signal.

In various embodiments, an index of a frame, a subframe or a slot is used because the index is not subordinate to another factor and various values may be selected. As the index of a frame, a subframe or a slot increases sequentially, it is a variable that changes irrespective of the communication environment or channel quality of devices. However, according to other embodiments, instead of the index of a frame, a subframe or a slot, other information related to a resource delivering a signal may be used to determine a label or a label index. Specifically, for information related to the resource, at least one of a frequency index, the number of resource blocks (RBs), a RB index, a start symbol index, an SSB detection time, or a repetition number of data signal may be used. Other information may also be used.

In the following examples of structures, an AI model is applied to some physical layers of a transmitting device and a receiving device.

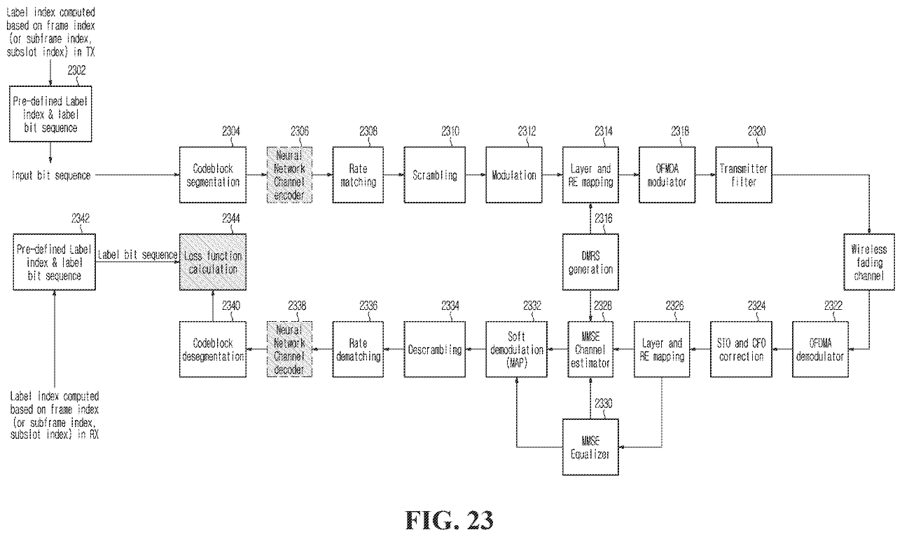

As an example, an online learning scenario for a neural network-based channel encoder and decoder, which replace an LDPC encoder and an LDPC decoder among functions of physical layers, may be described as follows. FIG. 23 illustrates examples of a transmitting device and a receiving device that perform channel encoding/decoding by using an artificial intelligence (AI) model according to an embodiment of the present disclosure.

Referring to FIG. 23, in a transmitting device, a predefined label index and an input bit sequence output from a label bit sequence block 2302 are segmented into codeword units by a codebook segmentation block 2304 and are converted to codewords by a neural network channel encoder block 2306. Next, the codewords are converted into modulated symbols through a rate matching block 2308, a scrambling block 2310 and the modulation block 2312. Then, the modulated symbols and DMRSs output from a DMRS generation block 2316 are mapped to layers and REs by a layer and RE mapping block 231 and are converted into an

OFDM symbol by an OFDM modulator 2318. Next, the OFDM symbol passes a transmitter filter block 2320 and is transmitted through a wireless channel.

A signal, which has passed through a wireless channel, is received by a receiving device. The received signal is converted into per-subcarrier modulated symbols by an OFDM demodulation block 2322, and a time and/or frequence offset is corrected by a sample timing offset (STO) and carrier frequency offset (CFO) correction block 2324. Then, a DMRS and modulated symbols are extracted by a layer and RE demapping block 2328, and channel estimation is performed in an MMSE channel estimator block 2328, and an equalizing action based on a channel estimation result is performed in an MMSE equalizer block 2330. Next, bit information (e.g., LLR value) is generated by a soft demodulation block 2332, a descrambling block 2334 and a rate dematching block 2336, and the bit information is input into a neural network channel decoder 2338. The neural network channel decoder 2338 outputs bits, which are not subject to channel encoding yet, and the bits are converted into a bit sequence by a codebook desegmentation block 2340. The restored bit sequence, the predefined label index and a label output from the label bit sequence block 2342 are input into a loss function calculation block 2344 and are used to determine a loss function. That is, the loss function calculation block 2344 determines a loss value by using the restored bit sequence, the predefined label index and the label output from the label bit sequence block 2342.

As shown in the example of FIG. 23, unlike the existing CRC, a loss may be calculated based on a predefined label, and learning may be performed. For example, a loss may include cross-entropy. In addition, in the example of FIG. 23, feedback on an error gradient is given for learning of a neural network channel encoder included in a transmitting device.

According to an embodiment, in a process of calculating an error gradient, a receiving device may easily calculate a gradient of a neural network channel decoder, but the difficulty is in calculating the inverse of blocks that perform intermediate actions to deliver gradient information to the transmitting device. Herein, a gradient according to an error may be calculated and delivered by approximating every procedure between the channel encoder of the transmitting device and the channel decoder of the receiving device by a Gaussian channel. This is because it is possible to consider that whitening has been performed through the MMSE equalizer block 2330 although channel fading is present.

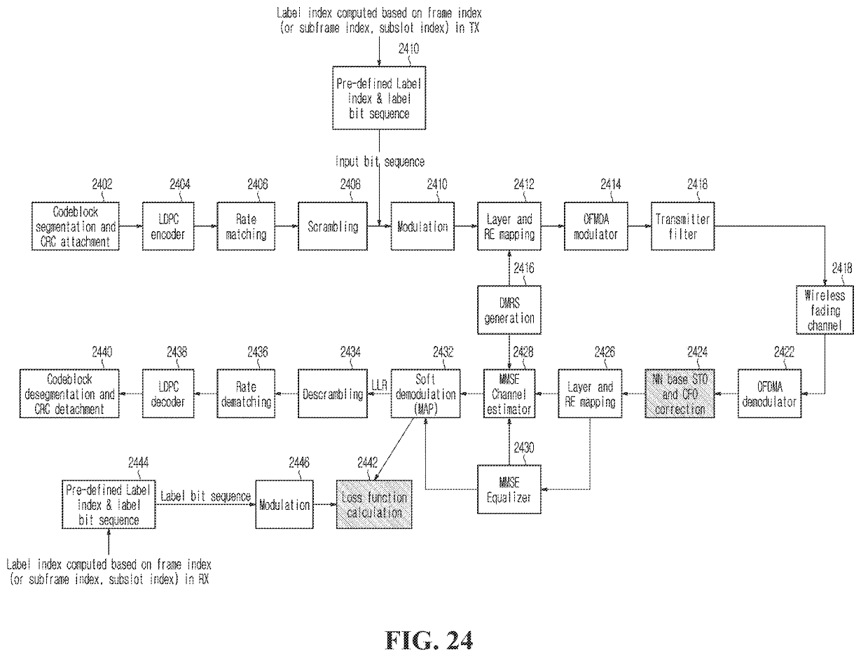

As another example, FIG. 24 shows a case in which a block for performing STO and CFO correction is replaced by a neural network-based functional block. FIG. 24 illustrates examples of a transmitting device and a receiving device that perform offset estimation and compensation by using an artificial intelligence (AI) model according to an embodiment of the present disclosure.

Referring to FIG. 24, in a transmitting device, information bits are segmented into codeword units by a codebook segmentation and CRC attachment block 2402, are connected to a CRC and are converted into codewords by an LDPC encoder block 2404. Next, the codewords are converted by a rate matching block 2406 and a scrambling block 2408 and then are converted into modulated symbols through a modulation block 2412. However, in this embodiment, the output of the scrambling block 2408 is not input into the modulation block 2412, but a predefined label index and label data output from a label bit sequence block 2410 are input into the modulation block 2412 and are converted into modulated symbols. Then, the modulated symbols and DMRSs output from a DMRS generation block 2416 are mapped to layers and REs by a layer and RE mapping block 2414 and are converted into an OFDM symbol by an OFDM modulator 2418. Next, the OFDM symbol passes a transmitter filter block 2420 and is transmitted through a wireless channel.

A signal, which has passed through a wireless channel, is received by a receiving device. The received signal is converted into per-subcarrier modulated symbols by an OFDM demodulation block 2422, and a time and/or frequence offset is corrected by a neural network-based STO and CFO correction block 2424. Then, a DMRS and modulated symbols are extracted by a layer and RE demapping block 2426, and channel estimation is performed in an MMSE channel estimator block 2428, and an equalizing action based on a channel estimation result is performed in an MMSE equalizer block 2430. Next, bit information (e.g., LLR value) is generated by a soft demodulation block 2432, a descrambling block 2434 and a rate dematching block 2436, and the bit information is input into an LDPC decoder 2438. The LDPC decoder 2438 outputs bits, which are not subject to channel encoding yet, and the bits are converted into a bit sequence by a codebook desegmentation and CRC detachment block 2440. Herein, the output of the soft demodulation block 2432 is input into a loss function calculation block 2444. In addition, the predefined label index and the output of the label bit sequence block 2444 are converted into modulated symbols by the modulation block 2446 and then are input into the loss function calculation block 2442. The loss function calculation block 2442 determines a loss value by using the output of the soft demodulation block 2432 and the modulated symbols generated by the modulation block 2446.

Herein, online learning may be performed through channel coding, and learning may also be performed at an uncoded bit level. Referring to FIG. 24, in case a bit sequence is input directly into a modulation block, a receiving device may calculate a mean square error (MSE) between two signals as a loss function by comparing a demodulated constellation point and a modulation of a label bit sequence. Alternatively, the receiving device may make a hard decision on LLR and then calculate cross-entropy at a bit level as a loss function. In FIG. 24, a gradient calculated based on an error may be used to update a neural network in a receiving device, and no feedback may be given to a transmitting device.

In examples as shown in FIG. 23 and FIG. 24, one block or a pair of blocks are replaced by functional blocks based on a neural network, but the present disclosure is not limited thereto. Specifically, as an application example of an AI model, FIG. 23 exemplifies a channel encoder/decoder with a neural network structure, and FIG. 24 exemplifies an STO and CFO correction block with a neural network structure. However, various embodiments of the present disclosure may be applied to a case in which another functional block is designed as an AI model. For example, a channel estimator, an equalizer and all the other blocks included in the receiving device and the transmitting device illustrated in FIG. 23 and FIG. 24 may be designed to have a neural network structure and be trained according to various embodiments of the present disclosure.

A container size according to a label data size may be acted by scheduling. Also, in addition to an index of a frame, a subframe or a slot, a lowest frequency index or starting symbol index, which is scheduled in DCI, may be further used.

In the case of the above-described uncoded bit sequence, a rule for modulation is needed. It is similar to an existing reference signal (RS) pattern using a preassigned random sequence, but a modulation scheme may be operated in various ways according to an index of a frame, a subframe or a slot. In other words, apart from constellations for modulation schemes applicable to typical data or RSs, constellations with a different structure may be defined and used for learning.

For example, in case learning is needed for a neural network that performs a phase-related task (e.g., STO and/or CFO correction), more accurate learning may be derived using a PSK modulation scheme. On the other hand, in case learning is needed for a task related to non-linearity of a channel (e.g., a task related to a feature of PA), a learning label needs to be generated using two or more modulation schemes that belong to 16QAM or PSK and have different sizes. According to an embodiment, a rule like “modulation pattern=function (bit sequence from frame index, frame index)” may be defined.

Herein, by applying a modulation scheme, a bit sequence obtained from an index of a frame, a subframe or a slot may be converted into a signal label that is modulated according to a frame index. That is, a bit sequence determined based on an index of a frame, a subframe or a slot may be converted into modulated symbols, and at this time, a modulation scheme may be determined based on the index of the frame, the subframe or the slot. For example, in case 16-PSK for phase learning and 16-QAM for non-linearity learning are used together, if the quotient of the division of a frame index by 16 is an odd number, a bit sequence may be modulated to 16-PSK, and if the quotient is an even number, the bit sequence may be modulated to 16-QAM. As another example, the number of used modulation schemes are equal to or greater than 3, the modulation schemes may be selectively applied based on a result of modular arithmetic for a frame index.

Accordingly, a receiving device may identify a modulation scheme by using a bit sequence that is determined based on an index of a frame, a subframe or a slot, and then restore data by processing (e.g., demodulating) a received signal in the identified modulation scheme. Alternatively, the receiving device may determine an estimation for a modulated symbol sequence based on a received signal, generate the modulated symbol sequence as a label by modulating the label in an identified modulation scheme, and then perform learning by using the estimation for the modulated symbol sequence and the label.

Herein, available modulation schemes and the number of modulation schemes may be preassigned. Several or dozens of modulation schemes may be used, and modulation schemes available as a label in a terminal may be configured through separate signaling. That is, the number of modulation schemes and the modulation schemes, which are described above, may be operated differently according to UE-specific learning purposes. Accordingly, in a process of negotiating capability for online learning, the number of modulation schemes and modulation schemes may be preassigned.

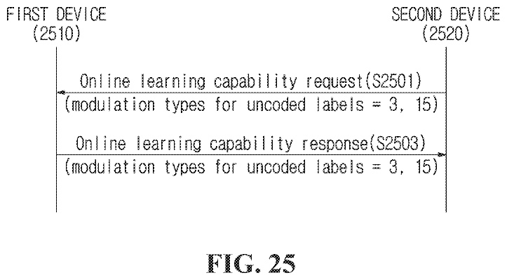

FIG. 25 illustrates an example of a procedure for signaling learning-related capability information according to an embodiment of the present disclosure. FIG. 25 exemplifies signal exchange for obtaining capability information related to online learning of an AI model (e.g., a neural network model) used in at least one of a first device 2510 and a second device 2520.

Referring to FIG. 25, at step S2501, the second device 2520 transmits an online learning capability request message to the first device 2510. According to an embodiment, the online learning capability request message may indicate at least one modulation scheme for an uncoded label. For example, the online learning capability request message may indicate modulation schemes of Index 3 and Index 5.

At step S2503, the first device 2510 transmits an online learning capability response message to the second device 2520. According to an embodiment, the online learning capability response message may indicate at least one modulation scheme for an uncoded label. For example, the online learning capability response message may indicate modulation schemes of Index 3 and Index 5.

As shown in FIG. 25, modulation schemes to be used may be configured through capability information. Thus, a set of modulation schemes for uncoding prior to initiation of online learning and corresponding types may be preassigned. Then, during learning, devices may variably operate modulation schemes based on an index of a frame, a subframe or a slot according to a corresponding modulation scheme. To this end, available candidate modulation schemes need to be predefined. Examples of available candidate modulation schemes are shown in Table 3 below.

TABLE 3

| Index | Modulation scheme |
|---|---|
| 1 | BPSK |
| 2 | QPSK |
| 3 | 8-PSK |
| . . . | . . . |
| 15 | 16QAM |
| 16 | 64QAM |

In the examples of Table 3, modulation schemes are exemplified as schemes based on existing constellations. However, modulation schemes for online learning may be defined in many other ways. Accordingly, apart from the names in Table 3, modulation schemes may be represented by designating coordinates of constellation points. For example, it is possible to use a modulation scheme based on a constellation that is defined as {(1,j), (−1,−j)} or {(1,j), (−1,−j), (1,−j)}.

As described above, a bit sequence and a modulation scheme may be determined by using an index of a frame, a subframe or a slot. However, according to another embodiment, a modulation scheme may be separately signaled. In case a signal including label data is transmitted, DCI or SCI for the signal needs to be transmitted. Herein, since the DCI or SCI includes information on an MCS level (hereinafter, ‘MCS field’), the MCS field may be used to indicate a modulation scheme that is applied to a label. However, in the case of DCI or SCI for a signal including label data, interpretation of an MCS field may be different from a general data signal. That is, when generating and interpreting DCI or SCI transmitted during an online learning segment, devices may generate and interpret an MCS field based on a modulation scheme table (e.g., Table 3) according to various embodiments of the present disclosure, not an MCS table applied to general datal.

Although the proposed methods described above may be independently implemented, they may also be implemented in a combination (or merger) of some of them. A rule may be defined so that information on whether to apply the proposed methods (or information on the rules of the proposal methods) is notified from a base station to a terminal through a predefined signal (e.g., a physical layer signal or an upper layer signal).

The present disclosure may be embodied in other specific forms without departing from the technical ideas and essential features described in the present disclosure. Therefore, the above detailed description should not be construed as limiting in all respects and should be considered illustrative. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

### INDUSTRIAL APPLICABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1-18. (canceled)

19. A method for operating a first device in a wireless communication, the method comprising:
receiving control information from a second device;
receiving a data signal based on the control information;
restoring data included in the data signal; and
performing learning for an artificial intelligence (AI) model used for communication by using the restored data,
wherein the learning is performed by using a label that is determined based on information related to a resource delivering the control information or the data signal.

20. The method of claim 19, wherein the information related to the resource includes at least one of a frame index, a subframe index, a slot index, a subcarrier index, a frequency index, a number of resource blocks (RBs), a RB index, a start symbol index, or a synchronization signal and broadcast block (SSB) detection time.

21. The method of claim 19, further comprising transmitting feedback information related to the data to the second device.

22. The method of claim 21, wherein the feedback information includes information related to a gradient that is generated by a backpropagating action of a neural network used in the first device.

23. The method of claim 19, wherein the label includes a bit sequence corresponding to an index that is determined based on the information related to the resource, and
wherein a corresponding relationship between the index and the bit sequence is predefined.

24. The method of claim 19, wherein the performing of the learning for the AI model comprises:
determining a loss value based on an error between the restored data and the label; and
performing a backpropagating action based on the loss value.

25. The method of claim 24, wherein the AI model includes at least one of a neural network-based channel estimator, a neural network-based channel decoder, a neural network-based sample timing offset (STO) and carrier frequency offset (CFO) correction block, a channel estimation block or an equalization block.

26. The method of claim 19, wherein the restoring of the data comprises:
determining, based on the label, a modulation scheme used for modulating the data; and
restoring the data based on the modulation scheme.

27. The method of claim 19, wherein the label is generated by modulating a bit sequence, which is determined based on the information related to the resource delivering the control information or the data signal, by a modulation scheme determined based on the bit sequence.

28. A method comprising:
transmitting control information to a first device;
generating a data signal; and
transmitting the data signal based on the control information,
wherein the data signal is generated based on a label used to perform learning for an artificial intelligence (AI) model that is used by the first device to process the data signal, and
wherein the label is determined based on information related to a resource delivering the control information or the data signal.

29. The method of claim 28, further comprising receiving feedback information related to the data from the first device.

30. The method of claim 29, wherein the feedback information includes information related to a gradient that is generated by a backpropagating action of a neural network used in the first device.

31. The method of claim 30, further comprising performing learning for an artificial intelligence (AI) model used in the second device based on the label and the information related to the gradient.

32. A first device comprising:
a transceiver; and
a processor coupled with the transceiver,
wherein the processor is configured to:
receive control information from a second device,
receive a data signal based on the control information,
restore data included in the data signal, and
perform learning for an artificial intelligence (AI) model used for communication by using the restored data, and
wherein the learning is performed by using a label that is determined based on information related to a resource delivering the control information or the data signal.

33. The first device of claim 32, wherein the information related to the resource includes at least one of a frame index, a subframe index, a slot index, a subcarrier index, a frequency index, a number of resource blocks (RBs), a RB index, a start symbol index, or a synchronization signal and broadcast block (SSB) detection time.

34. The first device of claim 32, the processor is further configured to:
Transmit feedback information related to the data to the second device.

35. The first device of claim 34, wherein the feedback information includes information related to a gradient that is generated by a backpropagating action of a neural network used in the first device.

36. The first device of claim 32, wherein the label includes a bit sequence corresponding to an index that is determined based on the information related to the resource, and
wherein a corresponding relationship between the index and the bit sequence is predefined.

37. The first device of claim 32, wherein the processor is further configured to:
determining a loss value based on an error between the restored data and the label; and
performing a backpropagating action based on the loss value.

38. The first device of claim 32, wherein the processor is further configured to:
determining, based on the label, a modulation scheme used for modulating the data; and
restoring the data based on the modulation scheme.
